(19) United States
(12) Patent Application Publication
(10) Pub. No.: US 2013/0068205 A1
(43) Pub. Date: Mar. 21, 2013

(54) TWO-STROKE ENGINE AND LUBRICATION

(71) Applicant: Jay Sirangala Veerathappa, Los Angeles, CA (US)

(72) Inventor: Jay Sirangala Veerathappa, Los Angeles, CA (US)

(21) Appl. No.: 13/284,948

(22) Filed: Oct. 30, 2011

Related U.S. Application Data
(60) Provisional application No. 61/535,990, filed on Sep. 17, 2011.

(51) Int. Cl. F02B 33/04; F01M 11/00

(52) U.S. Cl. 123/73 PP; 123/196 R

(57) ABSTRACT

Various embodiments include a two-stroke engine and a carburetor for use with gaseous fuel, such as hydrogen, methane, liquid petroleum gas, pure propane, and butane.

### RELATED APPLICATIONS

The present application is a Continuation-In-Part of U.S. Patent Application number 2011-0073064 A1, filed Sep. 25, 2010, entitled “INTEGRALLY CAST BLOCK AND GASEOUS FUEL INJECTED GENERATOR ENGINE”; and claims the benefit of priority of U.S. provisional application No. 61/535,990, filed Sep. 17, 2011, entitled “TWO-STROKE ENGINE AND LUBRICATION”, and of U.S. provisional application No. 61/313,801, filed Mar. 14, 2010, entitled “STRATIFIED TWO-STROKE ENGINE AND FUEL”, and of U.S. provisional application No. 61/252,685, filed Oct. 18, 2009, entitled “INTEGRALLY CAST BLOCK AND GASEOUS FUEL INJECTED GENERATOR ENGINE”, the entirety of each of which is incorporated by reference herein for all purposes.

### BACKGROUND

Some conventional gasoline fueled four-stroke engines used in hand-held applications, such as in trimmers and blowers, and in gaseous fueled blowers, are environmentally friendly. However, there are drawbacks to these engines. Namely these engines are very heavy and cannot be operated upside down for extended time, and the same design cannot be used in chainsaws. Alternative two stroke engines are advantageous, but very high in emission levels. A typical gaseous fueled two-stroke trimmer engine is a conventional two-stroke engine, which has significantly higher pollutants in the exhaust than do comparable four-stroke engines. Some conventional two-stroke engines sold in the US have catalysts to lower the emission levels.

It is known in the engine industry that there are gaseous fueled two-stroke engines with oil injection systems. However, these engines are of conventional type which have high emission levels, while the cleaner stratified engines are gasoline fueled and typically have oil pre-mixed with the gasoline. The disadvantage with gasoline fueled engines is that fuel spills smell bad, and the fuel evaporates when stored for long periods of time. Further, users need to pre-mix oil for lubrication, which can harm the catalysts, and as such emission levels may be bad toward the end of the life of the catalyst and/or the engine. Moreover, a user may forget to mix oil with the gasoline, which results in a scuffed engine.

Various embodiments described herein include a gaseous fueled stratified two-stroke engine with a dual passage carburetor to lower emissions, and oil injection to lubricate the engine. The engine may further be fitted with catalysts to reduce the pollutants, with potential reductions to well below the legal limits. The gaseous fuel may be Butane, CNG, Methane, Hydrogen, Propane, or a mixture of any gaseous fuels in any ratio. The engine can be used in many hand-held, lawn garden and mobile applications, such as in chainsaws, trimmers and scooters.

### SUMMARY

Various embodiments describe a two-stroke engine and carburetor for use with gaseous fuel, such as H2, methane, LPG, pure propane, or butane. The two stroke engine is especially suited for lawn and garden tools such as chainsaws, trimmers, blowers, pumps, and scooters.

Various embodiments reduce emissions significantly when LPG or Butane is used as fuel. In such cases, emissions may include only water vapor and N2. Emissions may also be reduced when H2is used, and may include water vapor, N2, and NOx.

Further, various embodiments provide a new lubricating system wherein the oil injection pump is driven by the crankshaft or belt or gear drive off of the crankshaft. Alternatively, the oil pump may be a diaphragm pump with or without a plunger. The oil may be injected into the intake, particularly into the air-fuel mixture passage, or into the crankcase, and may also be injected into the transfer passage, particularly at the bottom of the passage in a stratified engine where air is drawn into the crankcase through the transfer passage. The gaseous fuel tank is attached to the bottom of the crankcase or at the top of the engine above the cylinder. In various embodiments described here, the oil pump is driven off an out-board shaft which may not be concentric with the inboard shaft, such that it becomes economical to build such engines. In various embodiments, the oil sump is on the outboard side having a common wall to the crankcase chamber (or separate wall to reduce heating up of oil). The outboard shaft has a slinger inside the oil sump to generate oil vapors and/or fine droplets of oil for induction into the engine for lubricating the engine.

### BRIEF DESCRIPTION OF THE DRAWINGS

FIG. 1 is a sectional diagram of a special gaseous fuel carburetor and the engine 100 with the charge tube.

FIG. 2 is a sectional diagram of a dual passage gaseous fuel carburetor and the air-head stratified engine 200.

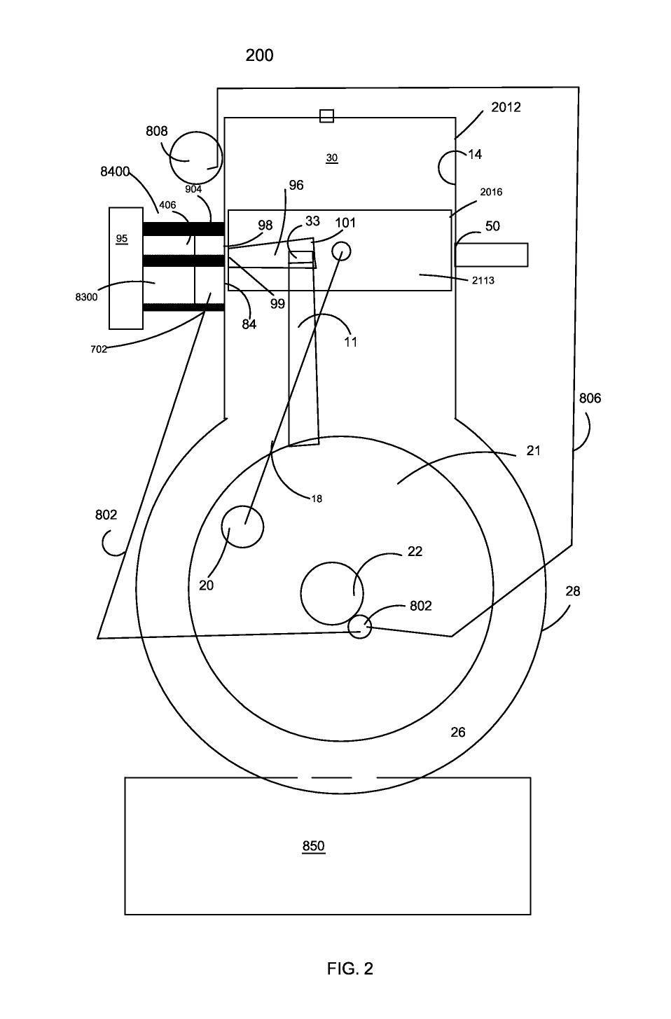

FIG. 3 is a cross sectional diagram of the engine shown in FIG. 2 having an oil pump.

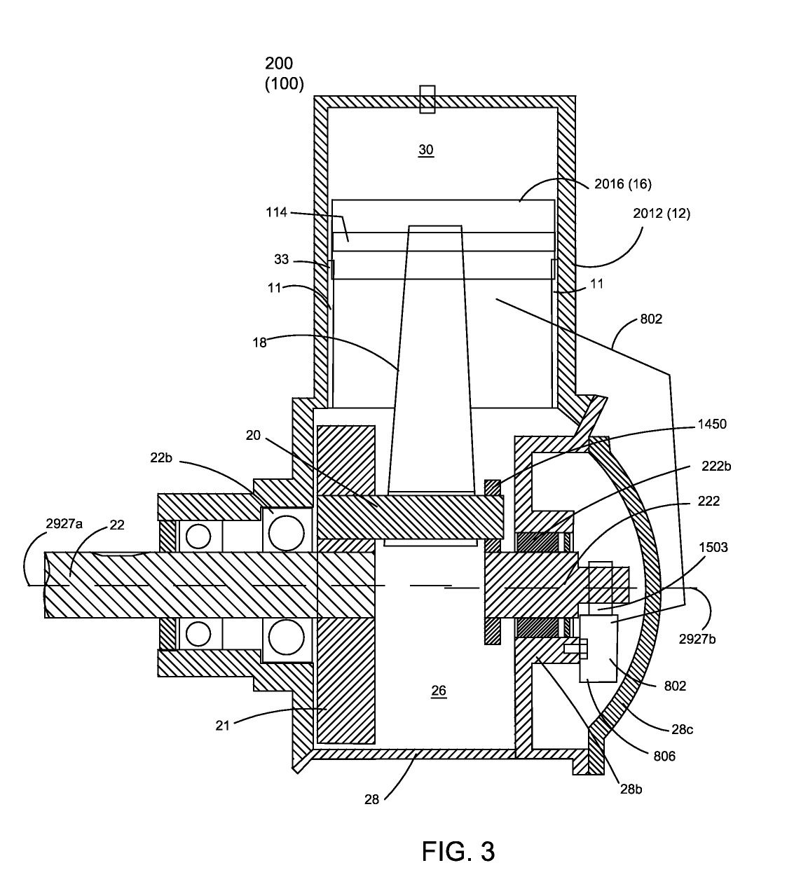

FIG. 4 is a cross sectional diagram of a two-stroke engine having an oil sump.

### DETAILED DESCRIPTION

The following are hereby incorporated by reference herein for all purposes: U.S. Pat. Nos. 6,901,892, 4,253,433, 6,273,037, 5,918,574, 6,293,235, 6,901,892, and 6,112,708.

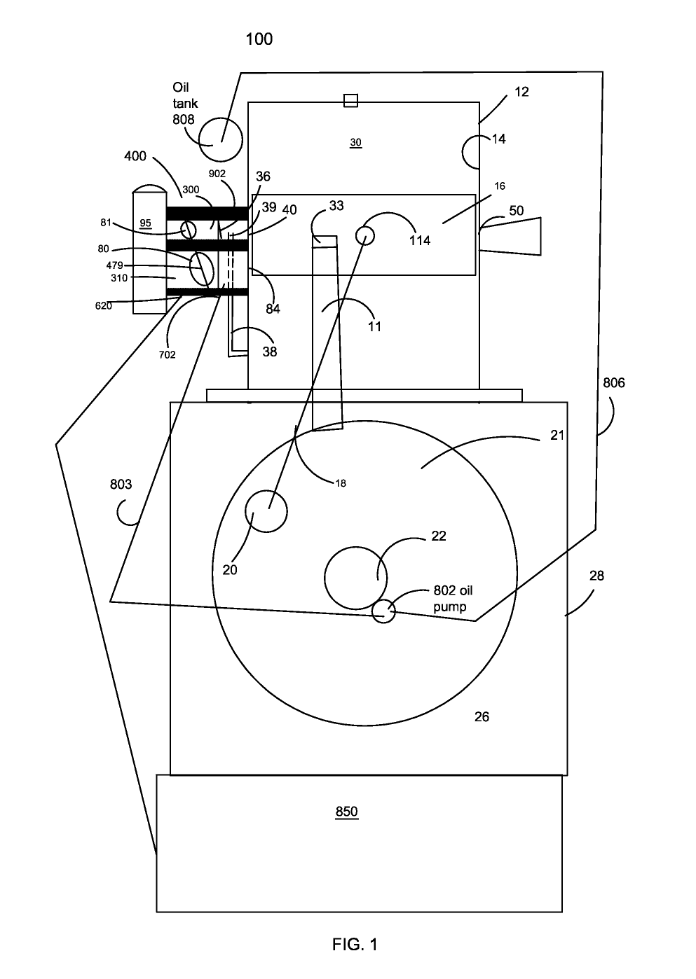

FIGS. 1, through 4 show various embodiments of two-stroke gaseous fueled oil injected engines with special gaseous fueled carburetors having built in pressure regulator and metering chambers. The two-stroke engines are of stratified type having either a rich charge tube or air-head scavenging as described in U.S. Pat. Nos. 6,901,892, 4,253,433, and 6,273,037. Various embodiments overcome drawbacks of conventional engines that use gasoline as fuel, in that oil need no longer be pre-mixed. Various embodiments improve upon conventional engines (e.g., the gaseous fuel two-stroke engine made by Mitsubishi as described in U.S. Pat. No. 5,918,574) by providing a stratified engine, which has significantly reduced emissions levels. Further, the most commonly used conventional gaseous fueled carburetors are not suitable for stratified engines. Although there exist conventional gasoline fueled stratified carburetors, these are not made to handle gaseous fuels. Therefore various embodiments described herein would be beneficial to help the environment and reduce dependence on liquid fuels.

U.S. Pat. No. 6,901,892 for example describes a charge stratified engine in its first figure. The operating principle of the innovative engine 100 disclosed in the present embodiments is similar to the engine 10 in the above reference. As such it will be understood that a person who has knowledge of engines will be in a position to execute the embodiments disclosed herein.

Turning to FIG. 1 of the presently disclosed embodiments, Engine 100 consists of a cylinder 12 inside which is a reciprocating piston 16 connected to a crankshaft 22 through a connecting rod 18, a crankpin 20 and a piston pin 114. The crankshaft 22 has crank weight 21 and the crankshaft is supported by main bearings. The crankshaft 22 is supported on both ends in a full crank engine, or on just one side in a half crank engine. The lower side of the piston has crankcase chamber 26 in the crank case 28. The cylinder 12 has cylinder bore 14 having combustion chamber 30 on the upper side of the piston 16. The crankcase chamber and combustion chamber are interconnected periodically through transfer passage 11. The cylinder has at least one intake port 84, exhaust port 50, at least one transfer port 33 and an injection port 40. The injection port 40 is connected intermittently to the crankcase chamber 26. The lubricating system consists of an oil pump 802 driven by the crankshaft, typically mounted to the side of the crankcase wall. Oil pump 802 has an inlet oil line 806 and receives oil from oil tank 808. Oil pump 802 also has an outlet pipe 803 for injecting oil into the intake passage 310 downstream of the lean valve 80 and possibly into the heat dam 902.

The special gaseous carburetor 400 shown in FIG. 1 has at least two passages, including a rich charge passage 300 and a lean charge passage 310. The gaseous fuel carburetor has at least one pressure regulating chamber and a metering chamber.

The gaseous carburetor 400 has a rich charge passage 300 supplying rich charge (rich fuel-air mixture) into the injection tube 38, through a one-way valve 36 in the intake heat dam 902. This is described in U.S. Pat. Nos. 6,901,892 and 6,293,235. The lean passage 310 supplies lean charge (lean fuel-air mixture) with oil into the crankcase chamber 26. The intake and scavenging process is explained in detail in U.S. Pat. No. 6,901,892 and others. It will be appreciated that a person skilled in the art will understand the operating principle by reading the U.S. Pat. Nos. 6,901,892 and 6,293,235 in their entirety. However, in the presently disclosed embodiments, the oil is injected into lean charge in the lean passage 310, preferably at the intake heat dam 902. The flow of the rich and the lean charge into the engine are regulated by the respective control valves 81 and 80. Both the valves 81 and 80 are mounted on to a common throttle shaft 479. However, they may be mounted on separate throttle shafts linked to each other and may be at phase with each other. Also, in the presently disclosed embodiments, the undercut (or a through hole) in the throttle shaft 479 in the rich charge passage may act as a throttle valve 81 and not have a separate valve. It is to be understood that the dual valves may be of any type, including butterfly valves, rotary valves (also known as barrel valves), and slide valve, which are commonly known to the person skilled in the art.

Further various embodiments include a dual passage carburetor 8400 for air-head stratified engines. U.S. Pat. Nos. 6,901,892 and 6,112,708 describe in detail the operating principles of an air-head stratified engine.

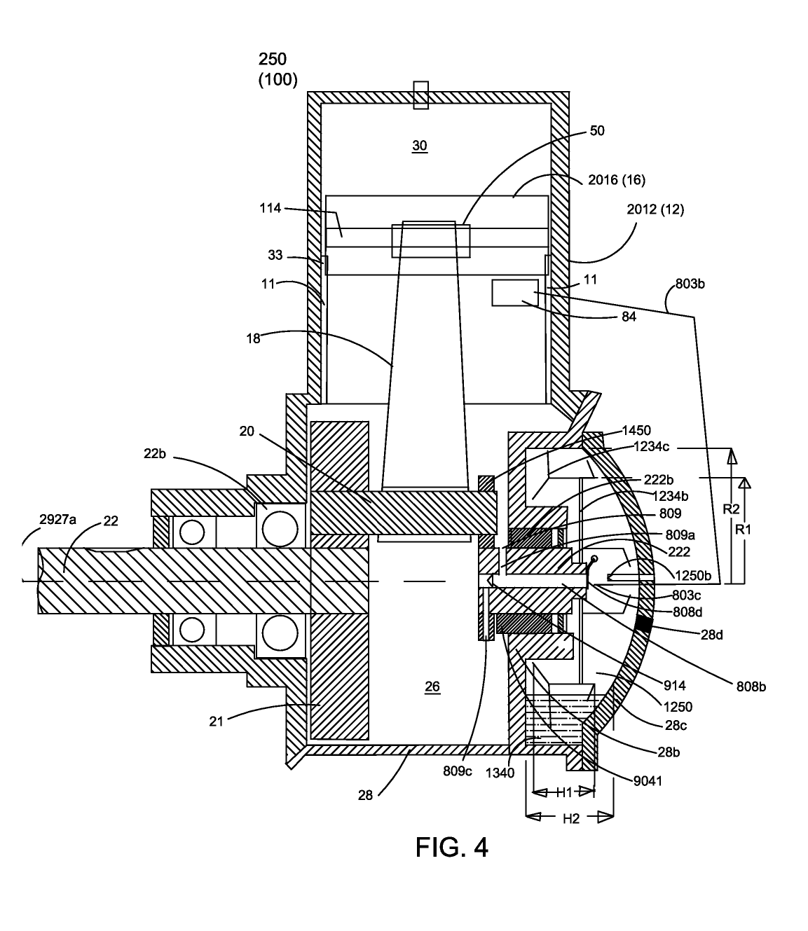

Referring to FIG. 4 of the present disclosure, engine 200 consists of a cylinder 2012 inside which is a reciprocating piston 2016 connected to the crankshaft 22 through a connecting rod 18, a crankpin 20 and a piston pin 114. The crankshaft 22 has crank weight 21 and the crankshaft is supported by main bearings either on both ends (in a full crank engine), or just on one side in a half crank engine. An outboard shaft 222 loosely connected to the crankpin 20 through a yoke 1450 is shown in FIG. 4b, which is a sectional view of the half crank engine 200. An oil pump 802 may be driven by the outboard shaft 222. As shown the axis 2927a of the crankshaft 22 and the axis 2927b of the outboard shaft 222 may not be in line and need not be in line, in some embodiments, because the yoke 1450 has a slot and accounts for any misalignment between the shafts. In various embodiments, the outboard shaft (222) is offset from the crankshaft (22). In various embodiments, the outboard shaft (222) is parallel to, but not in line with the crankshaft (22). The lower side of the piston has crankcase chamber 26 in the crank case 28. The cylinder 2012 has cylinder bore 14 having combustion chamber 30 on the upper side of the piston 2016. The crankcase chamber 26 and combustion chamber 30 are interconnected periodically through transfer passage 11 and transfer port 33. The cylinder 2012 has at least one intake port 84 for air-fuel mixture, at least one air inlet port, exhaust port 50, and at least one transfer port 33. The engine operates like a conventional two-stroke engine. First and second piston ports 99 and 101 are disposed on the skirt 2113 of the piston 2016 and are connected to each other in gaseous communication by air channel 96. A description of an air-head engine is contained in U.S. Pat. No. 6,901,892. The lubricating system consists of an oil pump 802 driven by the crankshaft, typically mounted to the side of the crankcase wall. Oil pump 802 has an inlet oil line 806 and receives oil from oil tank 808 and has an outlet pipe 803 injecting oil into the intake passage 310 downstream of the lean valve 80 and possibly into the heat dam 904. The engine 200 described is referred to as a piston ported air-head engine. It must be understood that the air-head stratified engine may also be a reed valve air-head stratified engine, where in the air is inducted into the transfer passage 11 through a reed valve (also known as one-way valve) as described in U.S. Pat. No. 6,901,892 in its figure thirty-one. However, in various embodiments, the rotary valve may open and close the opening of the transfer passage in the crankcase chamber. An outboard shaft (222) driven oil pump is also described in FIG. 25 in the U.S. provisional application 61/252,685 filed on Oct. 18, 2009 and in the U.S. provisional application 61/277,476 filed Sep. 26, 2009. It must be understood that the air-head engine can also use a reed valve in the air passage as described in the prior art.

Further FIG. 4c shows the oil sump 1250 on the outboard side. The outboard shaft 222 driven by the crankpin 20 through the arm 1450 is either solidly attached to the crank pin 20 or loosely attached. The outboard shaft 222 has slinger 1234b attached to it and the slinger has fingers (1234c) extended outwardly at the extreme ends and one set (1234d) at the center. The purpose of the slinger with the fingers is to churn/splash the oil 1340 as the engine runs and create oil vapors and/or small oil droplets. The oil vapor and/or droplets are inducted into the crankcase chamber 26 directly through the passage 808b or into the intake port 84 through a throttle valve to lubricate the internal parts. Since the engine is a two-stroke engine, oil inducted into the crankcase chamber 26 is eventually transferred into the combustion chamber 30 through the transfer passage 11. The oil inducted into the engine is burnt and, unlike with four-stroke engines, it is not re-circulated. However, various embodiments contemplate at least partial recovery of the oil.

In the case where the oil is inducted into the crankcase chamber 26 directly through the central passage 808b, there can be a check valve or one-way valve 914 to induct oil when the piston 2016 (16) is moving upward, particularly from about BDC to until about before the intake port 84 or air port (or reed valve opens as in air-head engine) opens. The oil sump 1250 may have a breather (1250b) having a one-way check valve to allow for ambient air to enter into the oil sump 1250, which eventually mixes with oil droplets and or oil vapors and is inducted into the crankcase chamber 26. The oil sump cover 28c may be of translucent material so the level of the oil is visible to the operator. The oil sump may also have an oil level sensor to shut off ignition if the oil level is below a certain level. The oil sump and slingers with fingers are designed such that the engine can be operated in any attitude without the raw oil getting into the inlet of the passage 808b or 803c. In the case that the oil is inducted through the central passage 808b, then the opening and closing of the oil passage into the crankcase chamber may be timed by the opening and closing of the opening 809 at the open end of the radial passage 809a, by the cut out on the sleeve 222b. The design of having oil sump on outboard side and oil passage in the crankshaft is also described US Patent Application number 2011-0073064 A1, which has a similar design, but for a four-stroke engine. The oil passage 808b may also have a centrifugal (as described in the application 2011-0073064 A1) valve to prevent the oil from getting into the crankcase chamber when the engine is not running. Secondly the opening of the passage 808b (and 803c) in the oil sump 1250 is such that the oil never gets into the opening when the engine is stored or operated in any attitude. In the case that the oil passage 808b opens straight into the crankcase chamber 26, the passage can have a check valve 914 such that the positive pressure, as the piston moves downward (or due to blow-by) in the crankcase chamber does not draw oil from the oil sump. As the piston moves upward, the sub-atmospheric pressure in the crankcase chamber causes the oil vapor/droplets to be drawn into the crankcase chamber 26 and the amount of suction may be regulated by a self regulating valve. For instance, when the engine is running at part throttle or at idle, less oil is supplied. When the engine is running at wider throttle position, more oil is supplied or is supplied through a separate throttle valve. The oil is periodically filled to a marked level through an oil filler and may have an oil level indicator (28d) as in any engine. The oil passage may have a centrifugal valve 808b to shut off the passage when the engine is not running and open the passage as the engine RPM increases. The self regulation may be due to combined effects of the governing weight, spring, RPM, and suction in the passage. As the sub-atmospheric pressure is lower at part throttle, the opening of the valve may be restricted, even though the centrifugal force tries to open the valve. Alternatively, a tapered plunger (not shown) in the central oil passage 808b attached to the centrifugal valve may vary the oil getting into the crankcase chamber 26 depending on the engine RPM. In this case, it may also work as a shut off valve when the engine is not running. Therefore the amount of oil vapor/droplets entering the crankcase chamber may be self-regulating. The end point of the oil tube 803b may be on the upstream or downstream side of the carburetor throttle valve and the amount of vapor may be regulated by the throttle valve, which may control the air-fuel or just the oil vapor.

Further, the crankshaft 222 may be extended through the oil sump cover 28c, as shown in FIG. 24 of the application 2011-0073064 A1, to have a provision for a starter, either of conventional or electrically driven type. Further, the excess oil in the crankcase chamber may return to the oil sump, as described in the application 2011-0073064 A1. The embodiments described can be used in any type of two-stroke engines, including, without limitation, carbureted, gaseous fueled two-stroke, liquid fueled two-stroke, fuel injected two-stroke engine, stratified engines, etc. However, various embodiments would be especially beneficial in a gaseous fueled two-stroke engine, particularly involving hand-held applications, where the product will likely to be operated in many attitudes, including up-side down. This is because the oil passage is located in the oil sump such that the raw oil never reaches the opening no matter the attitude in which the engine is operated or stored.

In various embodiments, the oil sump 1250 is substantially circular in shape. In various embodiments, the sump is disc like or doughnut shaped. In various embodiments, the radial clearance (R2−R1) between the slinger and outer circumferential wall is substantially uniform throughout the 360 degrees, except where oil filler is. In various embodiments, the axial clearance (H2−H1) between the slinger and the walls of the oil sump is substantially uniform.

Further the FIG. 4 shows different embodiments for oil passages and valves for lubricating the two-stroke engine. However, it will be appreciated that any one type can be used. The oil is injected into the air-fuel passage 8300 downstream of the air-fuel valve 881 through an oil injector. The oil may also be injected directly into the crankcase chamber 26 through the side wall of the crankcase 28 or may also be injected through a central hole in the crankshaft 22 and through a cross drilled hole in the counter weight (not shown). When injected directly into crankcase chamber or through crankshaft, it eliminates the need for oil feed line 803. Also, the oil tank may be attached to the side of the crankcase on the outside between the starter housing and the crankcase outer wall. It will be appreciated that the carburetors 400 and 8400 may be combined to form a three-way carburetor as described in U.S. Pat. No. 6,901,892. However, this would result in a gaseous fuel with oil injection into lean charge passage. Also, the control valves may be of any type, including butterfly valve, barrel or rotary valve, or slide valve.

It is also possible for rich fuel to be inducted into the injection tube 38 and the opening into the crankcase chamber 26 be periodically opened and closed by the cut out on the counter weight 21, as described in U.S. Pat. No. 6,901,892. Also, it is possible that the pure air with or without oil injected into the air can be inducted into the crankcase chamber 26 through transfer ports 33, as in the air-head engine described in U.S. Pat. No. 6,901,892 In such patent, the air inlet is through a one way valve or through the air channel in the piston.

Various embodiments include a carburetor that advantageously has a built-in pressure regulating chamber, because fuel supplied to the carburetor is already under pressure. Various embodiments utilize a fuel compressing liquefied petroleum gas. In some embodiments, the fuel could be natural gas, hydrogen gas, or any type of fuel essentially free of oil. The fuel may also be injected using an electronic fuel injection system.

### PARTS LIST

100 Engine
11 transfer passage
12 Cylinder
14 cylinder wall
16 Piston
18 connecting rod
20 crank pin
22 crankshaft
26 crankcase chamber
28 crankcase
30 Combustion chamber
33 transfer port
36 One way valve
38 Injection tube
40 charge injection port
50 Exhaust port
80 Lean valve
81 Rich valve
84 Intake port
95 Air-filter box
101 Piston pin
220 Rich fuel passage
300 Rich charge passage
310 Lean passage
479 Throttle shaft
620 Fuel inlet
702 Oil injector
802 oil outlet tube
804 oil pump
806 oil inlet tube
808 oil tank
850 Gaseous fuel tank
902 Heat dam
200 Engine
94 Air valve
96 air channel
98 Air inlet port
99 first piston port
101 second piston port
406 Air passage
881 Air-fuel valve
904 Heat dam
2012 Cylinder
2016 Piston
2113 piston skirt
8300 Air-fuel passage
8310 Air passage
8320 Fuel passage Dual passage gaseous
8400 Carburetor
1250 oil sump
1250b Breather
808b oil passage in shaft 222
914 Check valve
809a Radial passage
809 Orifice (opening)
808d Centrifugal valve
9041 Sleeve
28d Oil level indicator
R1 Radius of the slinger 1234b
R2 Radius of the disc shaped oil sump 1250
H1 Width of the slinger 1234b
H2 Width of the disc shaped oil sump 1250

It is to be understood that other modifications of the disclosed embodiments shall be apparent to those skilled in the art from the teachings herein and, it is, therefore, desired to be secured in the appended claims all such modifications as fall within the true spirit and scope of the disclosed and contemplated embodiments.

1. An internal combustion engine comprising (200):
a cylinder (12) and a cylinder bore (14);
a crankshaft (22) having a counter weight (21);
an outboard shaft (222) having a yoke (1450);
a piston (2016) connected to the crankshaft (22) through a connecting rod (18) and a crankpin 20;
at least one transfer port (33);
at least one transfer passage (11);
at least one intake port (84);
at least one exhaust port (50);
a combustion chamber (30);
a crankcase chamber (26) intermittently connected to the combustion chamber (30);
an oil injection pump (802) driven by the outboard shaft (222).

2. The engine of claim 1 in which the crankcase chamber (26) is enclosed in a crankcase cover (28b), and in which the oil injection pump (802) is mounted on the crankcase cover (28b).

3. The engine of claim 2 in which the outboard shaft (222) is offset from the crankshaft (22).

4. An internal combustion engine comprising:
a cylinder (2012) and a cylinder bore (14);
a crankshaft (22) having a counter weight (21);
an outboard shaft (222);
a piston (2016) connected to the crankshaft (22) through a connecting rod (18) and a crankpin 20;
at least one transfer port (33);
at least one transfer passage (11);
at least one intake port (84);
at least one exhaust port (50);
a combustion chamber (30);
a crankcase chamber (26) intermittently connected to the combustion chamber (30);
an oil sump (1250);
at least one oil slinger (1234b) attached to the outboard shaft (222); and
at least one oil passage (808b) connecting the oil sump (1250) to the crankcase chamber (26).

5. An internal combustion engine comprising (250):
a cylinder (2012) and a cylinder bore (14);
a crankshaft (22) having a counter weight (21);
an outboard shaft (222);
a piston (2016) connected to the crankshaft (22) through a connecting rod (18) and a crankpin 20;
at least one transfer port (33);
at least one transfer passage (11);
at least one intake port (84);
at least one exhaust port (50);
a combustion chamber (30);
a crankcase chamber (26) intermittently connected to the combustion chamber (30);
an oil sump (1250);
at least one oil slinger (1234b); and
at least one oil tube (803b) connecting the oil sump (1250) to the intake passage (310).

6. The engine of claim 5 in which oil tube (803b) supplies oil mist to the engine.

7. The engine of claim 5 in which tip (803c) of oil tube (803b) in the oil sump (1250) is significantly at the center of the oil sump (1240) and is above the oil level at all engine attitudes.

8. The engine of claim 4 in which the oil passage (808b) has a valve (808d).

9. The engine of claim 8 in which the valve (808d) closes the passage 808b when the engine speed is below idling.

10. The engine of claim 8 in which the valve (808d) has a speed dependant position to control the flow of lubricant to the crankcase chamber (26).

11. The engine of claim 4 in which the oil passage (808b) has a radial passage 809a intermittently connected to the crankcase chamber (26).

12. The engine of claim 4 in which the oil passage (808b) has a check valve (914).

13. The engine of claim 4 in which the oil passage (808b) has yoke (1450) with a radial passage (809c).

14. The engine of claim 4 in which the oil sump (1250) has a breather.

15. The engine of claim 14 in which the oil breather has its tip 1250b above oil level at all attitudes.

16. The engine of claim 4, in which the centrifugal valve (808b) has a tapered plunger which has a position that is RPM dependant.

17. An internal combustion engine comprising:
a cylinder (2012) and a cylinder bore (14);
a crankshaft (22) having a counter weight (21);
an outboard shaft (222);
a piston (2016) connected to the crankshaft (22) through a connecting rod (18) and a crankpin 20;
a combustion chamber (30);
a crankcase chamber (26) intermittently connected to the combustion chamber (30);
an oil sump (1250);
at least one oil slinger (1234b) attached to the outboard shaft (222); and
at least one oil passage connecting the oil sump (1250) to the crankcase chamber (26).

18. The engine of claim 17 in which the outboard shaft (222) is a crankshaft.

19. The engine of claim 17, in which the engine is one of a two-stroke engine and a four-stroke engine.

20. The engine of claim 17, in which the engine uses one of: (a) gaseous fuel; (b) liquid fuel; and (c) liquefied gaseous fuel (LPG).

21. The engine of claim 15, in which the engine is a stratified two-stroke engine.

22. The engine of claim 21 further comprising a dual passage gaseous fueled carburetor.

23. The engine of claim 22 in which the carburetor has a first passage for air-fuel mixture and second passage for air only.

24. The engine of claim 21 further comprising a gaseous fuel tank attached to the crankcase.

25. The engine of claim 21 further comprising a gaseous fuel tank, in which the gaseous fuel tank is attached to the top of the remaining portion of the engine.

26. The engine of claim 17, in which the engine is a lawn and garden engine.

27. The engine of claim 17, in which the outboard shaft (222) is not concentric to the crankshaft (22).

28. The engine of claim 17, further comprising an air-fuel mixture passage, in which the engine has oil inducted into the air-fuel mixture passage.

29. The engine of claim 17, further comprising an air-fuel mixture passage, in which the engine has oil injected into the air-fuel mixture passage.

30. The engine of claim 17, further comprising an air-fuel mixture passage, in which the engine has oil injected into the crankcase chamber.

31. The engine of claim 19 further comprising a transfer passage, in which oil is injected into the transfer passage.

32. The engine of claim 19 further comprising:
an injection port (40); and
an injection tube (38).

33. The engine of claim 21, in which the engine is an air-head stratified engine.

34. The engine of claim 33, in which the engine is a piston ported air-head engine.

35. The engine of claim 33, in which the engine is a reed valve air-head engine.

36. The engine of claim 21, further comprising a dual passage gaseous fuel carburetor for oil induction through intake port (84).

37. An internal combustion engine comprising:
a cylinder (2012) and a cylinder bore (14);
a crankshaft (22) having a counter weight (21);
an outboard shaft (222);
a piston (2016) connected to the crankshaft (22) through a connecting rod (18) and a crankpin (20);
a combustion chamber (30);
a crankcase chamber (26) intermittently connected to the combustion chamber (30);
an oil sump (1250);
at least one oil slinger (1234b) attached to the outboard shaft (222); and
at least one oil passage connecting the oil sump (1250) to the crankcase chamber (26),
in which the outboard shaft (222) is not a load bearing shaft.

38. An internal combustion engine comprising:
a cylinder (2012) and a cylinder bore (14);
a crankshaft (22) having a counter weight (21);
an outboard shaft (222);
an inboard shaft (22);
a piston (2016) connected to the crankshaft (22) through a connecting rod (18) and a crankpin (20);
a combustion chamber (30);
a crankcase chamber (26) intermittently connected to the combustion chamber (30);
an oil sump (1250);
at least one oil slinger (1234b), in which the oil slinger (1234b) is attached to one of:
the outboard shaft (222); and the inboard shaft (22); and
at least one oil passage connecting the oil sump (1250) to the crankcase chamber (26), in which oil vapors or droplets mixed with air are inducted into the crankcase chamber (26).

39. An internal combustion engine comprising:
a cylinder (2012) and a cylinder bore (14);
a crankshaft (22) having a counter weight (21);
an outboard shaft (222);
a piston (2016) connected to the crankshaft (22) through a connecting rod (18) and a crankpin (20);
a combustion chamber (30);
a crankcase chamber (26) intermittently connected to the combustion chamber (30);
an oil sump (1250) having a cover, in which at least one section of the cover is translucent;
at least one oil slinger (1234b) attached to the outboard shaft (222);
at least one oil passage connecting the oil sump (1250) to the crankcase chamber (26), in which the oil passage is intermittently opened and closed into the crankcase chamber (26); and
a dual passage carburetor (8400).

40. The internal combustion engine of claim 39 further comprising:
a crankcase cover (28b), in which the crankcase cover (28b) forms one side wall of the oil sump (1250).

41. The engine of claim 39 in which:
the oil sump 1250 is substantially circular in shape;
the radial clearance (R2−R1) between the slinger and outer circumferential wall is substantially uniform throughout the 360 degrees, except where there is oil filler is; and
the axial clearance between (H2−H1) between the slinger and the walls of the oil sump is substantially uniform.
